(19) United States
(12) Patent Application Publication
(10) Pub. No.: US 2011/0016378 A1
(43) Pub. Date: Jan. 20, 2011

(54) SYSTEM AND METHOD OF AUTOMATICALLY IDENTIFYING AND MARKING HYPERIMAGES WHEN DISPLAYED

(75) Inventor: Leigh M. ROTHSCHILD, Sunny Isles Beach, FL (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: ARIEL INVENTIONS, LLC, Sunny Isles Beach, FL (US)

(21) Appl. No.: 12/889,000

(22) Filed: Sep. 23, 2010

Related U.S. Application Data
(63) Continuation-in-part of application No. 12/290,258, filed on Oct. 29, 2008.
Application No. 12/290,258 is a continuation of application No. 11/051,069, filed on Feb. 4, 2005, now Pat. No. 7,456,872.
Application No. 11/051,069 is a continuation-in-part of application No. 11/020,459, filed on Dec. 22, 2004.
Application No. 11/020,459 is a continuation-in-part of application No. 10/998,691, filed on Nov. 29, 2004, now Pat. No. 7,450,163.
Application No. 10/998,691 is a continuation-in-part of application No. 12/860,404, filed on Aug. 20, 2010.

(51) Int. Cl. G06F 17/00

(52) U.S. Cl. 715/205

(57) ABSTRACT

A method and apparatus for processing a digital image are disclosed. Information, materials and metadata may be associated with the image, thereby forming a HyperImage™. A method includes evaluating metadata associated with an image, determining that the image is a HyperImage™, and indicating to a user that the image is a HyperImage™.

### CROSS-REFERENCE TO RELATED APPLICATION

This application is a continuation in part of U.S. patent application Ser. No. 12/290,258, filed on Oct. 29, 2008, the entirety of which is incorporated herein by reference, and which is a continuation of U.S. patent application Ser. No. 11/051,069, filed on Feb. 4, 2005, now U.S. Pat. No. 7,456,872, the entirety of which is incorporated herein by reference, and which is a continuation in part of U.S. patent application Ser. No. 11/020,459, filed on Dec. 22, 2004, the entirety of which is incorporated herein by reference, and which is a continuation in part of U.S. patent application Ser. No. 10/998,691, filed on Nov. 29, 2004, now U.S. Pat. No. 7,450,163, the entirety of which is incorporated herein by reference. This application is a also a continuation in part of U.S. patent application Ser. No. 12/860,404, filed on Aug. 20, 2010, the entirety of which is incorporated herein by reference.

### STATEMENT REGARDING FEDERALLY SPONSORED RESEARCH OR DEVELOPMENT

n/a

### FIELD OF THE INVENTION

The present invention relates to a method and system for processing metadata of an image, and more particularly to identifying an image as a HyperImage™.

### BACKGROUND OF THE INVENTION

Millions of images are captured each day by individuals around the globe. Many of these images are stored in the local storage or external storage of a computer, from which they can be accessed and viewed at any time after image capture. Many of these digital images are uploaded to websites on the World Wide Web (Web). On the Web, other users can access and view the images. In many cases the user can also click on the image and be directed to a different part of a website or to a totally different website.

Digital images that are routinely captured usually contain embedded metadata that contain information about the digital image. This metadata may be automatically written by the photographic device that captures the image. This metadata may include user supplied information that is stored prior to image capture and may also include metadata automatically supplied by the image capture device, including geographic location, date and time of image capture, width, length, resolution, pim information, compression information, f-number, etc. This information may be made available to anyone who desires additional information about the image or the image's creator.

A method and apparatus for easily associating metadata and additional information associated with an image uploaded to the Web, accessing the metadata and additional information once the image is uploaded, and linking the metadata and additional information to the uploaded image, are described in U.S. patent application Ser. No. 12/884,941, filed on Sep. 17, 2010, the entirety of which is incorporated herein by reference. An image that is associated with the metadata and links to additional information related to the image is referred to herein as a HyperImage™.

HyperImages™ are digital images that allow the user to link to additional information associated with the images. When displayed on the user's computer, whether in local storage (external or internal memory) or transmitted to a user's local computer as part of a global computer network (such as the Internet), the user may not know that the digital images are HyperImages™ since the images may not be marked. For example, a HyperImage™ embedded in a webpage may not be identified as a Hyperimage™ The non-identification of the image may be intentional on the part of the website owner since the owner may not want the user to access the image and then be hyperlinked away from the publisher's website. This circumstance may be beneficial for the web site publisher, but it is not beneficial for the user accessing the website, since the user may want the additional information that the Hyperimage™ can provide.

Thus a system and method of identifying Hyperimages™ is needed. Further, a system and method of marking the Hyperimages™ is also needed.

### SUMMARY OF THE INVENTION

The present invention advantageously provides a method and system for processing a digital image. According to one aspect, the invention provides a method for indicating a HyperImage™. The method includes evaluating metadata associated with the image, determining that the image is a HyperImage™, and indicating to a user that the image is a HyperImage™.

According to another aspect, the invention provides a computer readable medium, containing computer readable instructions, that when executed by the computer, cause the computer to evaluate metadata associated with an image. By evaluating the metadata, the computer determines that the image is a HyperImage™. The computer indicates to a user that the image is a HyperImage™.

According to another aspect, the invention provides an apparatus for processing metadata of an image. The apparatus includes a memory and a processor. The memory stores the metadata in a location associated with the image. The processor examines the metadata and determines from the metadata that the image is a HyperImage™. The processor then indicates to a user that the image is a HyperImage™.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a network for storing, transferring, and processing digital images and metadata associated with the digital images according to principles of the present invention;

FIG. 2 is a block diagram of an exemplary computer for processing metadata according to principles of the present invention; and

FIG. 3 is a flow chart of an exemplary method for processing metadata of an image and identifying an image as a HyperImage™ according to principles of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for managing digital images. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

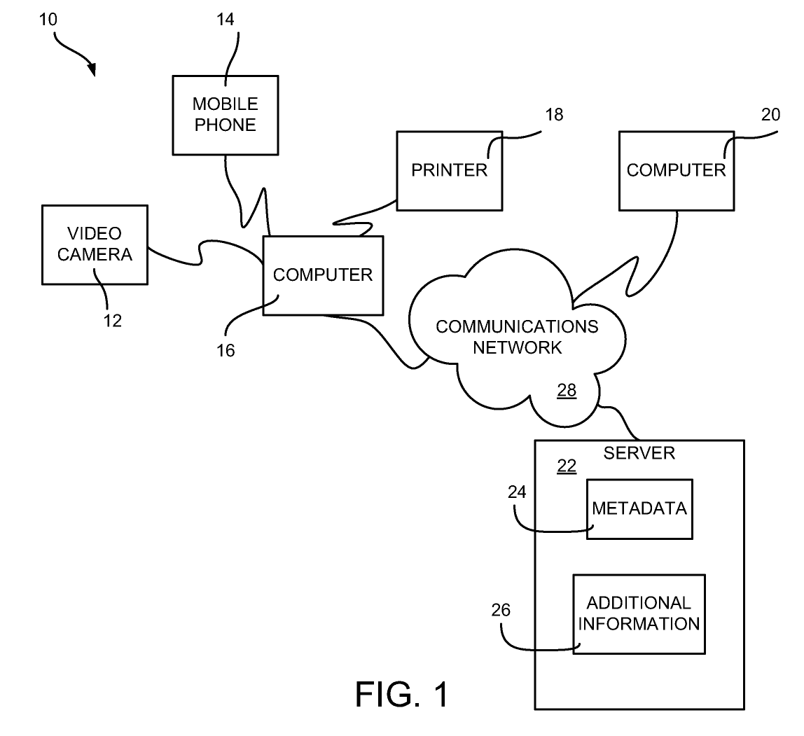

Referring now to the drawing figures in which reference designators refer to like elements, there is shown in FIG. 1 a block diagram of an exemplary system constructed in accordance with principles of the present invention, and generally designated as “10”. The system 10 provides a network for storing, transferring, and processing digital images and metadata associated with the digital images. A digital image may be captured by a camera 12 or a cell phone 14 (referred to collectively as a Mobile Image Capture Device (MICD)). MICDs may include the IPHONE by APPLE, ANDROID phones by GOOGLE, and other devices from other manufacturers.

The MICD can be linked to a computer 16, wirelessly or by wired/optical connection, to transfer a captured digital image and metadata associated with the image from the MICD 12 or 14 to the computer 16. Image and metadata transfer may be automatic or in response to input by a user of the MICD. Thus, the MICD may include a transmission module that implements cellular, WiFi, satellite, infrared, cable, Local Area Network (LAN), or other communications technology to transfer the image and its metadata to the computer 16. The computer 16 may be a laptop or desktop computer or portable computing device, such as a personal digital assistant. The image and metadata can be printed by a printer 18 in communication with the computer 16. Although FIG. 1 shows a single one of each device described herein, it is understood that more than one of these devices may be present.

As used herein, the term, “image,” includes a single captured image or a series of images, such as captured by a motion picture camera. The image may be stored as a jpg, bmp, tiff, avi, mpeg, rv, wmv, or other file type. The metadata associated with the image may also be stored as one of a known file type, and may include audio files (such as way, mp3, aiff, pcm, wma, etc.) The metadata of the image may be one of several standardized schemas for metadata, including EXIF, IPTC, XMP, Dublin Core and Plus. As described herein, metadata includes a field for a URL that may specify a location of the image or information related to the image. According to one embodiment, an address, such as a uniform resource locator (URL) where the image is stored, is embedded in the metadata. This address may be stored by a user before or after image capture.

In some embodiments, metadata can be associated with the captured image by the MICD 12 or 14. Additional metadata can be associated with the captured image by the computer 16. For example, a first set of metadata can be associated with the image by the MICD 12 or 14. This first set of metadata may be stored by a memory of the MICD. A second set of metadata can be associated with the image by the computer 16. This second set of metadata may be stored by a memory of the computer 16. Also, the user may associate materials with the image, in addition to the information of the metadata.

For example, the first set of metadata may include the creator's name, the time and date of capture of the image, an identification of the MICD that captured the image, characteristics of the image, including size, chroma, lighting, etc., the GPS coordinates of the MICD at the time of capture, the dimensions of the captured image, the f-number, resolution, compression information, an audio file, a video file, a multimedia file, etc. Some of the first set of metadata may be input before image capture by the user of the MICD, and some of the first set of metadata, such as GPS coordinates, can be automatically determined by the MICD. Some or all of the metadata may be displayed by a display of the MICD, to allow the user to edit and approve the metadata.

The second set of metadata may include audio files, video files, text files, multimedia files, uniform resource locators (URLs), a description of the captured image, information concerning image sizes, symbols such as barcodes, etc. Barcode data may be based on EAN, UPC, Code 25, MICROSOFT Tag, NEOMEDIA Mobile Tag, QR Tags or the Shop Savvy Barcode system. For example, a bar code may be printed and/or decoded to provide information about the image to a user.

Some of the first set of metadata can be input at the MICD 12 or 14 and some or all of the second set of metadata can be associated with the image at the computer 16. The computer 16 can be connected to a server 22 via the Internet or other network 28, including the Public Switched Telephone Network (PSTN). An image stored in the computer 16 can be copied, along with the metadata associated with the image, to the server 22. This transfer of the image and its metadata from the MICD or computer 16 to the server 22 may be performed at any time after image capture. In addition, the image and its metadata may be uploaded to the server 22 directly by the MICD 12 or 14. Thus, the server 22 may store metadata 24 and additional information 26 associated with an image.

Once uploaded, the image, its metadata, and additional information associated with the image may be accessible from the server 22 by another computer 20. Thus, in some embodiments, a file containing the image, its associated metadata, and links to related information can be uploaded to the server 22, where the image can be accessed at a website as a HyperImage™ accessible to a plurality of computers connected to the Internet. Note that the site containing the HyperImage™, its metadata, and additional information may not have any commercial nexus with the original author of the image, since ownership of the image may have been transferred or may be in the public domain. For example, an image uploaded to a social network site, such as FACEBOOK, may be in the public domain.

In some embodiments, an applet may be downloaded from a website at the request of a user. The applet enables a user to access or view metadata of an image. The website providing the applet may be the same as or different from the website where an image and its metadata are stored. The applet can automatically integrate into a web browser of the user or may remain separate. Current web browsers capable of integrating a downloaded applet include MICROSOFT INTERNET EXPLORER, GOOGLES'S CHROME, and MOZILLA FIREFOX, to name a few. The applet may be launched by clicking an icon provided on a tool bar of the web browser or may be launched by other input from the user.

When a user encounters a digital image of interest on the Web, he or she may select the image by clicking on the image, uttering a voice command, or otherwise indicating a selection of the image using a keyboard or mouse. The user may then launch the applet and a window may appear in response to launching the applet. The window may enable the user to view metadata or, alternatively, some or all of the metadata may be hidden from the user. The applet enables the user to view metadata by executing a metadata viewer to examine the metadata fields contained in the digital image file.

The applet may find and retrieve a URL located in the metadata. This URL address may be an address or pointer to a location of a file that contains additional information associated with the image. In one embodiment, the hyperlink is a link to a photo processing center. Examples of photo processing centers include WALMART, WALGREENS, COSTCO, FLICKR, and SONY IMAGESTATION among others. The metadata can then be processed at this center and the metadata can contain information concerning the type of processing requested by the owner of the images associated with the metadata.

Once the metadata viewer locates the URL address, the user may then be taken to the URL location either automatically or upon request. Whether the user is taken to the URL location automatically or upon request can be specified in advance by the user. At the URL location, a thumbnail and/or a large size copy of the image may be presented to the user. Also, the user may be presented with a list of additional information associated with the digital image. The additional information may include audio files, video files, multimedia files, text files, URL links and hyper links to other related materials, encoded symbology, GPS location information, variations of the image including higher definitions of the image or different sizes of the image. The user may then select any of the listed information to view or download.

Note that if there is only one type of material associated with the image, for example, a single audio file, then that file may be displayed, played, or activated automatically. Also, even if there are multiple materials associated with the image, anyone of them may be chosen to be activated automatically as a default when the user selects the image. For example, a user may select an image and in response to the selection, a video file may automatically be played. What is displayed automatically may be determined in advance by the person who uploads the HyperImage, its metadata, and associated materials, or may be determined by the website publisher. Thus, for example, the user may be given the option to pre-register what actions are to be taken in response to a user activating a HyperImage™. The pre-registered action preferences may include, without limitation, whether to activate an audio file, a text file, a video file, or a multi-media file, displaying a list of materials associated with the image, displaying metadata of the image, displaying a URL of the image, and redirecting the user's web browser to a URL location. These pre-registered action preferences may be stored locally or at a server in the network to which a user's computer is connected.

Thus, a user may capture an image using an MICD. The MICD may associate metadata with the image. The image and its metadata may be stored in a local memory of the MICD. A communications module of the MICD may transfer the image and its metadata to a local or remote computer or to external memory. The local or remote computer and the external memory may be connected to the Internet.

Once stored, a user (who may be different from the image author) may access the image at the storage location, and click on, or otherwise select the image. When the user selects the image, an applet may automatically be activated or may be activated upon selection by the user. The activated applet may activate a metadata viewer to examine the metadata fields, including a URL field, contained in the digital image file that has the image and the metadata. The metadata viewer may enable offline or online viewing of the metadata.

Once the metadata viewer ascertains the URL of the location where the image file is located, the user may be taken to the URL location automatically or upon request by the user. At that location, a thumbnail of the digital image may be shown to the user or alternatively a full size copy of the image may be displayed.

A list of materials associated with the image may also be displayed. These materials may include audio files, video files, multimedia files, text files, URLs and hyperlinks to other related materials, encoded symbology, GPS location information, higher definitions of the image, and different sizes of the image. Note that one or more of these related materials may be played, activated, or displayed automatically or upon selection by the user. The materials to be activated automatically may be chosen in advance by an author of the image or another person. For example, if a user selects an image from a local memory and then requests information about the image, an audio file may automatically activate and play, thereby giving the audio information about the image. The audio information may include a verbal statement about the image and may include music chosen by the author of the image. As another example, a video file having information about the image may be activated automatically or upon selection.

Note also that the user may print out the image and its metadata, including, if selected, encoded symbology associated with the image. This symbology may be used by the MICD or a scanning device and may direct the user to the location of the image and its metadata. The user may also email the image and its metadata as a file attachment to an email. The user may also include a link in the email that points to a storage location of the image.

In some embodiments, a user, upon request, will be provided an applet that will integrate with the user's web browser. This applet will be an add-on to the user's web browser and may be accessed by clicking on an identified button shown on the web browser or by another input command designated by the applet, or may be automatically activated.

When an image or images (of any type including but not limited to .tiff, .jpg, .bmp, .png, etc.) are resident on the user's display screen, the add-on applet will activate a metadata viewer to examine the metadata fields contained in the digital image file. The add-on applet may examine the image's metadata and may parse out the field containing the URL storage address and a field containing an indication that the examined image is a Hyperimage™

By evaluating the metadata of an image, the applet may determine that the image is a Hyperimage™. This determination may be made based on the existence of a field in the metadata that indicates that the image is a Hyperimage™, or by the existence of a URL that links to associated materials. When the applet determines that the examined image is a HyperImage™, then the image will be marked by a computer software marking program (CSMP). The CSMP may mark the Hyperimage(s)™ in various fashions depending on the user's preset preferences. These preferences may be registered by the user at the device capturing the images or the local processor where the CSMP program is resident. In another embodiment of this disclosure the user could also register the preferences at a remote server location which will then connect to the computer processor that contains the CSMP.

A Hyperimage™ may be marked in a manner that enables the user to differentiate a HyperImage™ from a non-HyperImage. For example, a HyperImage™ may be marked by a silhouette, or a picture frame placed around the Hyperimages™. A logo that denotes that an image is a HyperImage™ may be placed as an overlay on the displayed digital image. A text file may be placed near or overlaying the HyperImage™. An audio file may be activated to alert the user that a Hyperimage™ or multiple HyperImages™ are resident at the currently viewed website. Alternatively, a video file may be activated to alert the user that one or more HyperImages™ are present. A list of information associated with the image may be placed on top of or near the image. Other indications that an image is a HyperImage™ may be employed. In one embodiment, a feature that indicates that an image is a Hyperimage™ may be activated when a cursor is passed over the image.

Note that any combination of these choices may be activated by the CSMP depending on user preferences, which may be entered by the user in advance. For example, when a Hyperimage™ is identified by the CSMP, the image may be marked with a Hyperimage™ logo and an audio file activated to tell the user that there are Hyperimages™ on display.

In another embodiment, the CSMP may identify a Hyperimage™ and the user may left-mouse-click on the image to bring up a list of materials associated with the Hyperimage™ When the user right clicks on the image, the user may then be taken to where the website has linked the image. For example, if the Hyperimage™ is located at a CNN (Cable News Network) webpage, and the user right clicks on the image, the user would be hyperlinked to the accompanying story (on a new webpage) that relates to the selected image. The action(s) to be taken when a user activates the Hyperimage™ may be pre-selected and pre-registered either locally or remotely. These actions may include, without limitation, whether to activate an audio file, a video file, a text file, or a multimedia file, displaying a list of materials associated with the image, displaying metadata of the image, displaying a URL associated with the image, and redirecting the user's web browser to a URL found in the metadata of the image.

Note that, instead of a mouse click, the user may activate the Hyperimage™ by voice input or any other type of user directed input. The user may also roll the cursor over the HyperImage™ to produce a list of information associated with the HyperImages™. This rollover function may be turned on or off from the browser software applet by the user.

Note also, that the user does not have to be accessing the image stored at a remote website. For example, the image can be downloaded to the user's local computer and the local computer may have a CSMP that marks the HyperImage™ so that the user can identify the image as a HyperImage™

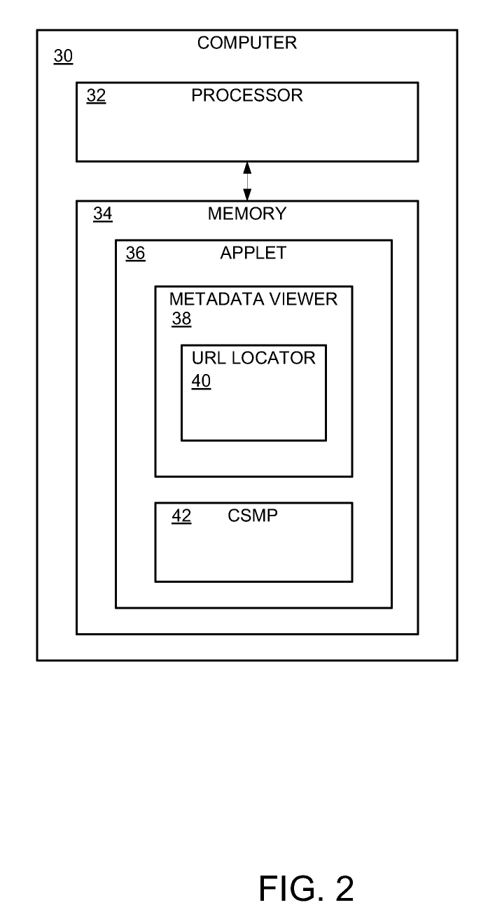

FIG. 2 is a block diagram of a computer 30 having a processor 32 and memory 34 for processing metadata as described herein. The computer 30 may be a desktop computer, a laptop computer, a personal digital assistant, a mobile device, a tablet PC, etc. The computer 30 has a processor 32 for executing computer instructions stored in the memory 34. The memory 34 may be a hard drive, Random Access Memory (RAM), Read Only Memory (ROM), flash memory, compact disc, external memory, etc. Computer instructions stored in the memory 34 include an applet 36 which includes a metadata viewer 38, which has a URL locator 40 that extracts a URL from the metadata. The applet may also include a CSMP (computer software marking program) 42 that marks an image as a HyperImage™ if a URL is found in the metadata of the image or the metadata otherwise indicates that the image is a HyperImage™

Thus, one embodiment is an apparatus for marking an image. The apparatus comprises a memory 34 and a processor 32. The memory 34 may store the metadata associated with an image in location associated with the image. The processor 32 may examine the metadata, determine from the metadata that the image is a HyperImage™, and indicate to a user that the image is a HyperImage™. Indicating that the image as a HyperImage™ may include displaying at least some of the metadata or data related to the image. The memory 34 may store an applet that contains instructions to perform the examining, determining, and indicating functions performed by the processor 32. The processor 32 may also alter a display associated with the HyperImage™ when a cursor is passed over the image. The alteration of the display in response to the cursor passing over the image may include displaying a list of information associated with the HyperImage™.

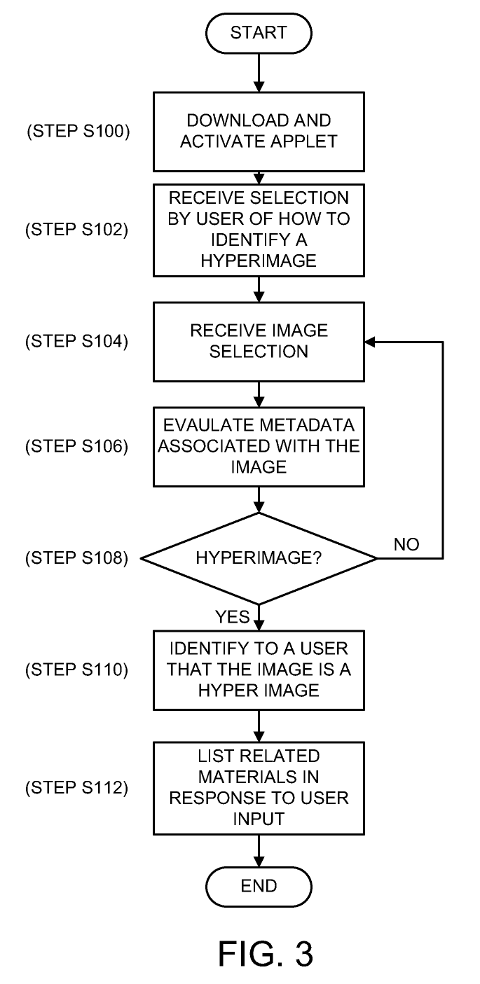

FIG. 3 is a flow chart of a method for processing metadata of an image and identifying an image as a HyperImage™. A user may download an applet that can view metadata of an image, determine if the image is a HyperImage™, and indicate to a user that the image is a HyperImage™ (Step S100). The user may select how a HyperImage™ is to be identified (Step S102). For example, the user may choose for a HyperImage™ to be identified by a silhouette. The user selects an image to be evaluated and identified and the selection is received by the applet (Step S 104). Upon selection of the image, or automatically in some embodiments, the applet evaluates the metadata associated with the image (Step S106). If it is determined that the image is not a HyperImage™, (Step S108), the user may select another image (Step S104). When it is determined that the image is a HyperImage™, (Step S108), the fact that the image is a HyperImage™ is communicated to the user (Step S110). Also, in response to user input, a list of related materials may be displayed (Step S112).

One embodiment of the invention is a computer readable medium, storing computer readable instructions, that when executed by the computer, cause the computer to perform operations for processing metadata related to an image. For example, the instructions may cause the computer to evaluate metadata associated with the image. The instructions may further cause the computer to determine from the evaluated metadata that the image is a HyperImage™. The instructions may further cause the processor to indicate to a user that the image is a HyperImage™. Evaluating the metadata may include inspecting predetermined fields of the metadata. Determining that the image is a HyperImage™ may include determining if a predetermined field of the metadata contains a URL. Indicating that the image is a HyperImage™ may include displaying at least one of a silhouette, a frame, an icon, a text descriptor, and a logo. Identifying the image as a HyperImage™ may include activating at least one of an audio file, a video file, and a text file. The computer readable instructions for performing these acts may be downloaded from the Internet.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for indicating a HyperImage™, the method comprising:
evaluating metadata associated with the image;
determining that the image is a HyperImage™; and
indicating to a user that the image is a HyperImage™.

2. The method of claim 1, wherein the HyperImage™ is indicated by displaying a feature with the image.

3. The method of claim 2, wherein the displayed feature is at least one of a silhouette, a picture frame, a logo, a text descriptor, and a list of information materials related to the image.

4. The method of claim 1, wherein the HyperImage™ is indicated by activating a file associated with the image.

5. The method of claim 4, wherein the activated file is one of an audio file, a video file, a multimedia file, and a text file.

6. The method of claim 1, wherein the evaluating, determining, and indicating is performed by execution of an applet.

7. The method of claim 1, wherein the determining includes determining if the metadata contains a uniform resource locator (URL).

8. The method of claim 7, wherein the URL corresponds to a remote location on a wide area network.

9. The method of claim 1, wherein the determining is initiated by an input from a user.

10. A computer readable medium, containing computer readable instructions, that when executed by the computer causes the computer to perform a method comprising:
evaluating metadata associated with an image;
determining from the evaluated metadata that the image is a HyperImage™; and
indicating to a user that the image is a HyperImage™.

11. The computer readable medium of claim 10, wherein the evaluating includes inspecting predetermined fields of the metadata.

12. The computer readable medium of claim 10, wherein the determining includes determining if a predetermined field of the metadata contains a uniform resource locator (URL).

13. The computer readable medium of claim 10, wherein the indicating includes displaying at least one of a silhouette, a frame, an icon, a logo and a text descriptor.

14. The computer readable medium of claim 10, wherein the indicating includes activating at least one of an audio file, a video file, a multimedia file, and a text file.

15. The computer readable medium of claim 10, wherein the computer readable instructions are obtained over the Internet.

16. An apparatus for processing metadata of an image, the apparatus comprising:
a memory, the memory storing the metadata in a location associated with the image; and
a processor in communication with the memory, the processor:
examining the metadata;
determining from the metadata that the image is a HyperImage™; and
indicating to a user that the image is a Hyperimage™.

17. The apparatus of claim 16, wherein the indicating includes displaying at least some of the metadata.

18. The apparatus of claim 16, wherein the processor alters a display associated with the HyperImage™ when a cursor is passed over the image.

19. The apparatus of claim 16, wherein the apparatus performs an action in response to activation of the Hyperimage™, the action being pre-specified.

20. The apparatus of claim 19, wherein the pre-specified action is stored locally on a computer of a user.
